(19) United States
(12) Patent Application Publication
(10) Pub. No.: US 2008/0283414 A1
(43) Pub. Date: Nov. 20, 2008

(54) Electrowetting devices

(76) Inventors: Charles W. Monroe, London (GB); Alexei Kornyshev, London (GB); Anthony R. John kucernak, London (GB); Alice E. Sylvia Sleightholme, London (GB); Michael Urbakh, Ramat Aviv (IL)

Correspondence Address: DICKSTEIN SHAPIRO LLP, 1825 EYE STREET NW, Washington, DC, 20006-5403, US

(21) Appl. No.: 11/798,901

(22) Filed: May 17, 2007

(51) Int. Cl. C25B 9/00; C02F 1/461

(52) U.S. Cl. 205/687; 204/242

(57) ABSTRACT

A device comprising: a chamber containing two immiscible conductive liquids, the liquids having an interface therebetween; and electrodes arranged to apply a voltage across the interface between the said liquids such as to control the shape of the interface.

This invention relates to the electrochemical principle of electrowetting and practical applications thereof.

### BACKGROUND TO THE INVENTION

The term “electrowetting” refers to the effect of an external electric field on the shape of a fluid/fluid interface in contact with a substrate [1]. This effect allows the manipulation of interfacial shapes by applied voltage. The magnitude of the electrowetting effect is controlled by the strength of an electric field, which is sustained by the imposition of a voltage difference across the operating fluids. Various applications of the electrowetting effect are in commercial development, including variable-focus lenses [2], microfluidic devices [3] such as channel switches, and electronic displays [4].

Known electrowetting devices employ a liquid/liquid interface formed between one conductive and one non-conductive liquid. This type of liquid junction is abbreviated below as the ‘n/c junction’. Applied to a non-metallic liquid, ‘conductive’ indicates the ability to transmit electricity via the free passage of ionic chemical species—either positively charged (cations) or negatively charged (anions), or both—through the interior of that liquid.

One known implementation, WO99/18456 (Lens with Variable Focus) asserts that n/c junctions are necessary to induce a significant electrowetting effect with liquid/liquid interfaces. All known subsequent implementations of the electrowetting effect rely on this method of system design. Academic study has focused mainly on the n/c junction, although some attention has also been given to the junction between two non-conductive liquids [1]. Use of the n/c junction is thought to decrease the likelihood of undesired electrochemical reactions, which may degrade chemical constituents of devices, thus shortening their operational lifetimes.

In known implementations of electrowetting, the body of the device contains at least two conductive electrodes. Applied to a metal or semiconductor, ‘conductive’ indicates the ability to transmit electricity via the free passage of electrons through the interior of that material. The electrodes connect to a power source, which may be an integral part of the device, or external to the device. The power source establishes a voltage difference between the conductive electrodes to regulate the electrowetting effect.

When a voltage is applied to operate an electrowetting system containing the n/c junction, high excess charge density may accumulate in the liquids near the three-phase (liquid/liquid/substrate) contact line [5]. This can encourage irreversible electrochemical side reactions, which may occur more easily when liquids contact conductive electrodes directly. In known implementations of electrowetting, the electrodes are therefore covered by non-conductive solid layers. These may consist of coatings, laminates, and/or separate parts of the device body. Said layers impede free electrons from reaching the operating liquids, preventing electrode corrosion or electrochemical degradation of the liquids. Thus, in known implementations the conductive operating liquid contacts a non-conductive substrate, which forms a separate part of the device.

Another motivation for covering the solid substrate with a non-conductor is to smooth the surface on which the three-phase contact line rests. Even when annealed or highly polished (either electrochemically or with fine abrasives), conductive solids may retain some residual surface roughness. Such roughness can pin the three-phase contact line in place. This pinning phenomenon may affect the repeatability or predictability of the electrowetting effect, and also lengthen the characteristic time taken for the liquid/liquid interfacial shape to equilibrate during device operation.

The operating voltages of electrowetting devices are dictated in part by the total system capacitance. In existing devices, operating voltages typically range across tens or hundreds of volts. Such high voltages are needed because non-conductive phases have very low specific capacitances. Non-conductive substrate layers can be made extremely thin; the non-conductive liquid, which usually has a comparatively large characteristic size, is therefore the main design factor that determines total specific capacitance. When a voltage is applied across the n/c junction, the resulting electric field is dispersed across the non-conductive liquid, and is not intense enough to affect significant liquid/liquid interfacial shape response unless the corresponding range of operating voltages is also very wide.

Usage of the n/c junction also limits options for device designs, because non-conductive liquids tend to consist of single molecular components (e.g. pure silicone oil). In addition to capacitance, an electrical property related to the dielectric constant of a substance, the fine control of mechanical properties such as liquid density or viscosity also may be needed to achieve particular design requirements. Often, such variations of mechanical and electrical properties cannot be achieved without replacing the non-conductive liquid with an entirely different chemical.

There is a desire, therefore: (1) to achieve the electrowetting effect at lower operating voltages by altering the chemistry of the operating liquids; (2) to develop a compositional chemistry which lowers said voltage whilst still avoiding undesired chemical reactions; (3) to bring about a method by which properties of both operating liquids can be adjusted independently without extensive changes to their chemical constituents; (4) to obviate the need for a protective, non-conductive substrate layer in device construction; and (5) to provide an operational procedure which may reduce pinning of the three-phase contact line on rough substrate surfaces.

### SUMMARY OF THE INVENTION

Inter alia, the present invention provides a method by which a junction between immiscible conductive liquids may be produced, whereby the conductive liquid/conductive liquid interface so formed is suitable to support the electrowetting effect. The interface between two immiscible conductive liquids, abbreviated herein as “ITICL,” is achieved via the incorporation of electrolytes into both of the immiscible liquids which form the liquid/liquid interface.

The use of an ITICL may enable the electrowetting effect to be actuated at a low applied voltage (typically less than one volt), which is advantageous for practical applications such as portable consumer devices. Low voltages may be used to regulate the electrowetting effect because the potential drops across an ITICL are localized very near the liquid/liquid and liquid/substrate interfaces, greatly increasing the system specific capacitance. This localization may also make the response of electrowetting systems containing an ITICL relatively insensitive to substrate geometry.

The term “electrolyte” as used herein should be interpreted broadly, to encompass any substance comprised entirely of ionic constituent species, with positive ionic species (cations) and negative ionic species (anions) present in such amounts that said substance is electrically neutral as a whole. The term “salt” may be used interchangeably herein.

The term “electrolytic solution” as used herein should be interpreted broadly, to encompass any substance which is a liquid at the operating temperature of interest, where said substance comprises an electrically neutral (molecular) solvent component in which at least one electrolyte is dissolved.

The term “ionic liquid” as used herein should be interpreted broadly, to encompass any substance which is a liquid at the operating temperature of interest, where said substance comprises an electrolyte only.

The term “conductive liquid” as used herein should be interpreted broadly, to encompass any electrolytic solution or ionic liquid in which the electrolyte is sufficiently concentrated to impart conductivity to that electrolytic solution or ionic liquid. This conductivity is needed to reduce the operating voltages required to induce the electrowetting effect. A conductive liquid may contain additional additives to modify its physical properties—for instance, to change its viscosity, density, refractive index, surface tension, etc.

The term “immiscible conductive liquids” as used herein should be interpreted broadly, to encompass any set of conductive liquids which separate naturally into distinct, mechanically homogeneous phases, with distinct interfaces formed between said phases. Immiscible conductive liquids may have a small mutual solubility, or contain mutually miscible additives, so long as said distinct interfaces form.

In one embodiment the ITICL may comprise two immiscible electrolytic solutions. The Interface between Two Immiscible Electrolytic Solutions is known as the “ITIES,” a technical field of research. The use of ITIES-based electrowetting configurations may simplify system design significantly, because the electrical, chemical, and/or mechanical properties of both liquids can be adjusted to some extent by changing electrolyte concentrations, without other significant alterations in the system composition.

According to a first aspect of the present invention there is provided a device as defined in claim 1 of the appended claims. Thus there is provided a device comprising: a chamber containing two immiscible conductive liquids, the liquids having an interface therebetween; and electrodes arranged to apply a voltage across the interface between the said liquids such as to control the shape of the interface.

Although the chamber is said to contain two immiscible conductive liquids, this should not be regarded as an exclusive or limiting number, since additional immiscible conductive liquids may also be provided within the chamber.

The term “chamber” as used herein should be interpreted broadly, to encompass any apparatus containing the two immiscible conductive liquids. The chamber may be enclosed on all sides, or may have an open top or other openings therein.

In certain embodiments, the chamber walls may constitute electrodes, which may be in direct contact with the ITICL during device operation. When in direct contact with conductive substrates, undesired electrochemical side reactions with the ITICL may be prevented or at least reduced by a suitable restriction on the operating-voltage range. Significant liquid/liquid interfacial shape changes can usually be achieved within this voltage range.

The device may further comprise a power supply to control the voltage across the ITICL. The power supply may be operable to vary the applied voltage, thereby enabling the curvature of the interface to be varied.

The term “control voltage” as used herein should be interpreted broadly, to encompass any steady-state potential difference maintained by the power supply. Said control voltage may be changed continuously or abruptly, enabling the curvature of the ITICL to be varied with respect to time.

The power supply may be further arranged to superimpose a small-amplitude oscillating voltage onto the control voltage. This may reduce hysteresis in the device response or improve the response time of the device.

According to a second aspect of the present invention there is provided a method for controlling the shape of an interface between two liquids, the method comprising: providing two immiscible conductive liquids in a chamber, the said liquids having an interface therebetween; and applying a voltage across the interface between the said liquids. The voltage across the interface may be provided by a power supply or other electrical device.

According to a third aspect of the invention there is provided a device comprising: a chamber containing two immiscible conductive liquids, the liquids having an interface therebetween; electrodes arranged to apply a control voltage across the interface between the said liquids such as to control the shape of the liquid/liquid interface; and a power supply arranged to apply the control voltage to the said electrodes; wherein the power supply is operable to vary the control voltage, and is arranged to apply a further superimposed oscillating voltage signal whilst varying the control voltage.

According to a fourth aspect of the invention there is provided a method for controlling the shape of an interface between two liquids, the method comprising: providing two immiscible conductive liquids in a chamber, the said liquids having an interface therebetween; applying a control voltage across the interface between the said liquids; varying the control voltage to control the shape of the interface between the said liquids; and applying a further superimposed oscillating voltage signal whilst varying the control voltage.

Possible applications include variable-focus lenses, micro-fluidic devices and electronic displays.

With all the aspects of the invention, optional features are defined in the dependent claims.

### BRIEF DESCRIPTION OF THE DRAWINGS

Embodiments of the invention will now be described, by way of example only, and with reference to the drawings in which:

FIG. 1 illustrates a device that may be used to characterize contact-angle variation with respect to control voltage for an ITICL;

FIG. 2 illustrates the experimental data for an ITICL configured in the geometry of FIG. 1, showing variation in contact angle with potential;

FIG. 3 illustrates curves for contact angle α_{c} as a function of control voltage, for a type 1A ITICL in the configuration depicted in FIG. 1;

FIG. 4 illustrates theoretical contact-angle response and partition potential φ_{*}/Δφ as a function of control voltage, for a type 1B ITICL in the configuration depicted in FIG. 1;

FIGS. 5 to 8 illustrate embodiments of devices employing electrowetting principles;

FIG. 9 illustrates shape change and charge accumulation with potential, as discussed in Appendix A; and

FIG. 10 compares three results yielded by equations (A.4)-(A.7) of Appendix A to the small-potential approximations provided by equations (A. 1) and (A.8) of Appendix A.

In the figures, like elements are indicated by like reference numerals throughout.

### DETAILED DESCRIPTION OF PREFERRED EMBODIMENTS

The present embodiments represent the best ways known to the applicants of putting the invention into practice. However, they are not the only ways in which this can be achieved.

### 1. Overview

A new class of electrowetting systems employing two ionically conductive liquids, i.e. an Interface between Two Immiscible Conductive Liquids (abbreviated herein as “ITICL”), is proposed. The three-phase contact line may occur directly between an ITICL and an electrical conductor, which may form one of the electrodes that controls the device. By specific choice of the ionic species and/or solvents, a very high electric field may be maintained near each two-phase interface in the device, without inducing undesired side reactions at said interfaces. Because the electric field is localised over a small distance near the interfaces, the electrowetting effect can be actuated at very low applied voltages—typically less than one volt—compared to those used in current electrowetting devices.

ITICL-based systems have practical advantages for electrowetting applications. In current devices, applied voltages in the range of 10-100 V are needed to achieve significant shape variation [1]. With the ITICL, similar shape changes may be induced with applied voltages in the hundreds of millivolts. As well as reducing the voltages for shape change, the response of ITICL-based electrowetting systems are relatively insensitive to electrode geometry.

An ITICL can be constructed, for example, on the basis of ITIES [6], [Appendix A]. Research on ITIES has involved adsorption characteristics, catalytic properties, mesoscale interfacial morphology, and the energetics of ion solvation [6]. The electrowetting properties of ITIES have gone relatively unnoticed.

### 2. Formation of an Interface Between Two Immiscible Conductive Liquids (ITICL) Suitable to Support the Electrowetting Effect

Aqueous electrolytic solutions, which may contain multiple electrolytes or additional trace additives, typically form the conductive liquid in existing implementations of electrowetting using the n/c junction. A number of aqueous solutions suitable to support the electrowetting effect are therefore well known. An exemplary aqueous electrolytic solution, utilized in one implementation described herein, is pure water containing dissolved lithium chloride at a concentration of 0.5 mol/L. Another salt which dissociates sufficiently to impart conductivity to an aqueous phase is tetraethylammonium (TEA) iodide at a concentration of 0.1 mol/L.

In accordance with the present embodiments, the non-conductive liquid phase present in known implementations may be replaced by a non-aqueous electrolyte or non-aqueous electrolytic solution, whilst still supporting the electrowetting effect. Incorporation of electrolytes can increase the specific capacitance of the nonaqueous liquid significantly, which may significantly lower the operating voltages for electrowetting.

Solvents suitable to create non-aqueous electrolytic solutions include nitrobenzene and 1,2-dichloroethane. Other non-aqueous solvents with dipole moments significantly different than water may be considered suitable for electrowetting applications. In both of the solvents stated, electrolyte concentrations greater than 0.01 mol/L have been found experimentally to create non-aqueous electrolytic solutions with sufficient conductivity to support the electrowetting effect. Electrolyte concentrations somewhat lower than 0.01 mol/L may also provide sufficient conductivity.

Exemplary non-aqueous electrolytic solutions are: nitrobenzene solvent, containing 0.01 mol/L (or higher) tetrabutylammonium tetraphenylborate (TBA-TPB) electrolyte, or 1,2-dichloroethane solvent, containing 0.01 mol/L (or higher) TBA-TPB. Non-aqueous electrolytic solutions may also be formed with either solvent, but with TBA replaced by another tetra-alkylated ammonium cation, such as TEA, tetrapentylammonium, etc. The TPB anion may similarly be exchanged for additionally functionalized phenylborates, such as tetrakis[3,5-bis(trifluoromethyl)phenyl]borate, or even for a simple halide, e.g. the iodide anion. The solvents and electrolytes listed here do not provide a comprehensive list of non-aqueous electrolytic solutions, but any combination of at least one of the exemplary solvents, at least one of the exemplary cations, and at least one of the exemplary anions may be used to create a non-aqueous electrolytic solution that may be suitable to support the electrowetting effect.

Any electrolyte in a liquid state is designated herein as an ionic liquid. Special classes of electrolytes, often referred to as “room-temperature ionic liquids,” exist in a liquid state below 100° C.; these may be the most suitable choices to form liquid/liquid interfaces in electrowetting devices. Room-temperature ionic liquids are most commonly formed from (1) a cation, which may consist of: a multiply alkylated amine, such as TEA; a functionally substituted phosphonium core, such as trihexyltetradecylphosphonium (P6,6,6,14); or a functionally substituted, ionized, nitrogen-containing heterocyclic core, which may be pyrrolidinium, imidazolium, pyridinium, isoquinolinium, etc., a particular example being 1-butyl-3-methylimidazolium (BMIM); and (2) an anion, which may be a halide, e.g. chloride or iodide; a simple organic, e.g. acetate; contain a fluorinated or otherwise functionalized semi-metal core atom, e.g. hexafluorophosphate, tetrafluoroborate, or tetraphenylborate; or be any of the group of anions containing the trifluouromethanesulfonate (CF₃SO₃⁻) functional group, e.g. trifluoromethanesulfonate (triflate) or (bis)trifluoromethane sulfonate imide (TFSI). These exemplary cations and anions do not provide an exhaustive list. Generally speaking, the structure of the cation may be most important in determining whether an electrolyte exists as a room-temperature ionic liquid.

There are several types of liquid/liquid junctions that can be formed between immiscible conductive liquids:
Type 1: contact of an electrolytic solution with an electrolytic solution
Type 2: contact of an electrolytic solution with an ionic liquid
Type 3: contact with an ionic liquid with an ionic liquid.

The most common liquid/liquid junctions of type 1 are based on one polar and one non-polar solvent (i.e. one molecular liquid with a large dipole moment and one with a small dipole moment). In type 1 junctions, immiscibility implies that the solvents which comprise the electrolytic solutions have low mutual solubility. Here “low” indicates that the solubilities of each solvent in the others are below an equilibrium mole fraction of approximately 0.02, although slightly higher mutual solubilities may be permissible. Water and 1,2-dichloroethane are suitable solvents to form a junction of type 1: at 298 K, the equilibrium mole fraction of 1,2-dichloroethane in water is ˜0.002, and that of water in 1,2-dichloroethane is ˜0.01 [8]. The water/nitrobenzene solvent pair has a lower mutual solubility, and has also been observed experimentally to form a liquid/liquid interface which may support the electrowetting effect.

A junction of type 1 may be a member of one of two sub-types:
Type 1A: a set of immiscible solvents containing a mutually miscible electrolyte.
Type 1B: a set of immiscible solvents, in which each particular solvent contains a particular dissolved electrolyte which is immiscible in the remaining solvents.

A type 1A junction may be formed by TEA-iodide in water, contacting a solution of TEA-iodide in nitrobenzene. Configuration 1B corresponds to the liquid/liquid junction referred to as an ITIES. An exemplary type 1B junction, or ITIES, is a solution of lithium chloride in water, contacting a solution of TBA-TPB in 1,2-dichloroethane. Junctions of either type 1A or 1B may create a distinct interface suitable to support the electrowetting effect.

A junction of type 2 may be formed by an aqueous electrolytic solution in contact with an ionic liquid with low affinity for water. Although many ionic liquids are hygroscopic, there are some in which this effect is minimal. For instance, in an ionic liquid consisting of BMIM-TFSI, the equilibrium mole fraction of water is ˜0.003 [9], sufficiently low that a type 2 junction may be formed with an aqueous electrolytic solution at room temperature. Other ionic liquids may be found with similarly low solubilities in water, or even in non-aqueous solvents, and thus be suitable to support the electrowetting effect.

A junction of type 3 may be formed by any suitable pair of mutually immiscible ionic liquids, a particular example being a system comprised of (P6,6,6,14)-chloride contacting BMIM-chloride [10]. At type 3 junctions, mutual ionic-liquid solubilities may rise up to mole fractions of 0.4, whilst still providing a distinct interface suitable to support the electrowetting effect.

The term ITICL refers specifically to a liquid/liquid junction of type 1A, 1B, 2 or 3. It may be possible to incorporate additional additives in any ITICL without inhibiting the electrowetting effect.

In an electrowetting system based on the movement of a three-phase contact line between a solid substrate and an ITICL, significant three-phase contact-angle changes may be induced with applied potentials less than 1 V. The nature of contact-angle change with potential may differ for a particular ITICL.

### 3. Choices of Conductive Substrates for ITICL-Based Electrowetting

In all embodiments of electrowetting devices discussed herein, the substrate on which the three-phase contact line occurs may comprise a conductive metal or semiconductor material. High voltages increase the risk of undesired electrode corrosion or electrochemical liquid degradation during system operation. Thus, by lowering the voltage at which the electrowetting effect is manifested, the use of an ITICL may also reduce the risk of side reactions. However, because the operating liquids are conductive, electrochemical reactions are unavoidable at some level of applied voltage.

The maximum voltage difference which can be applied to an ITICL without undesired side reactions may be determined by cyclic voltammetry. In the case of a type 1B junction, formed from 1 mol/L lithium chloride in water, contacting 0.01 mol/L TBA-TPB in 1,2-dichloroethane, cyclic voltammetry with a gold substrate showed that electrochemical reactions did not occur significantly (at currents less than 0.1 μA/cm²) at voltages between −800 mV and 200 mV vs. an Ag/AgCl reference electrode. Thus the “ideal polarizability window” for this type 1B junction against gold is 1 V. For a type 1B junction formed from 1 mol/L lithium chloride in water, contacting 0.01 mol/L TBA-TPB in nitrobenzene, against gold, the ideal polarizability window was also observed experimentally to be 1 V. Being chemically similar, type 1A interfaces using nitrobenzene and water, containing a dissolved TEA-iodide electrolyte, would be expected to show a similar range of ideal polarizability. A number of ionic liquids have been investigated which are also stable over a similar voltage range. Thus ITICL-based electrowetting may be implemented using conductive substrates in contact with junctions of types 2 or 3.

Substrates such as glassy carbon or indium-doped tin oxide have also been characterized experimentally against type 1B junctions, and have been found to have ideal polarizability windows that extend over a width of more than 1 V. Other metallic or semiconductor electrodes may be suitable to produce ideal polarizability windows of at least 1 V without inducing significant chemical reactions at the ITICL.

A suitable variation of conductive liquids or substrates may substantially affect the voltage range in which side reactions can be avoided, but does not change the operating principle of the system.

### 4. ITICL Device Implementation

### EXAMPLE 1

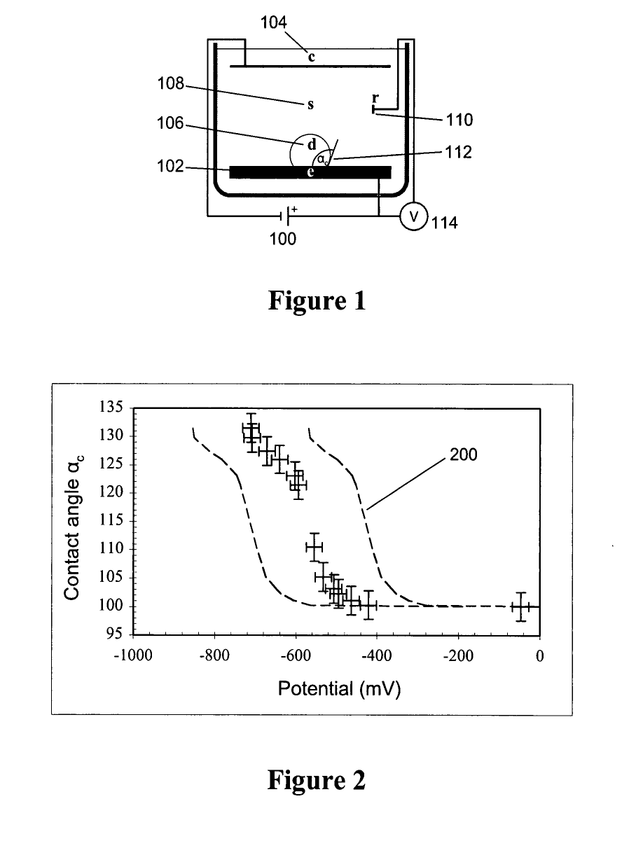

FIG. 1 illustrates a device that may be used to characterize contact-angle variation with voltage for an ITICL. The contact angle 112 of the liquid/liquid interface with the solid substrate is typically used to quantify interfacial shape. Voltage 100 is applied between planar working electrode 102 and a counterelectrode 104. Droplet 106 consists of a conductive liquid with volume ˜1 μL and the surrounding solution 108 is another, immiscible conductive liquid. 110 denotes a silver/silver chloride reference electrode, and the contact angle 112 of the droplet 106 on electrode 102 is labeled α_{c}.

FIG. 2 shows the experimental data for an ITIES configured in the geometry shown in FIG. 1. For these experiments, the droplet 106 was composed of 0.01 mol/L TBA-TPB in 1,2-dichloroethane, and the surrounding solution 108 was composed of 0.5 mol/L lithium chloride. The working electrode 102 consisted of glass, on top of which was sputter-coated a chromium layer, which in turn was sputter-coated with gold (thus a layer of pure gold formed the substrate in this implementation of the electrowetting effect). The counter electrode 104 consisted of a 5 cm length of 0.5 mm diameter gold wire. Experiments were performed at atmospheric pressure and 298 K. Contact-angle hysteresis on an untreated gold surface without a superimposed oscillating voltage is indicated with a dotted line, 200.

These curves show that a 30-degree contact angle variation can be achieved in the voltage range between 0 V and −0.8 V versus Ag/AgCl. This range of voltages is one or two orders of magnitude smaller than the corresponding range for conventional electrowetting systems based on the n/c junction.

Electrowetting devices based on the use of an ITICL may therefore be produced using applied voltages 10 to 100 times smaller than existing devices. This feature is beneficial for portable applications.

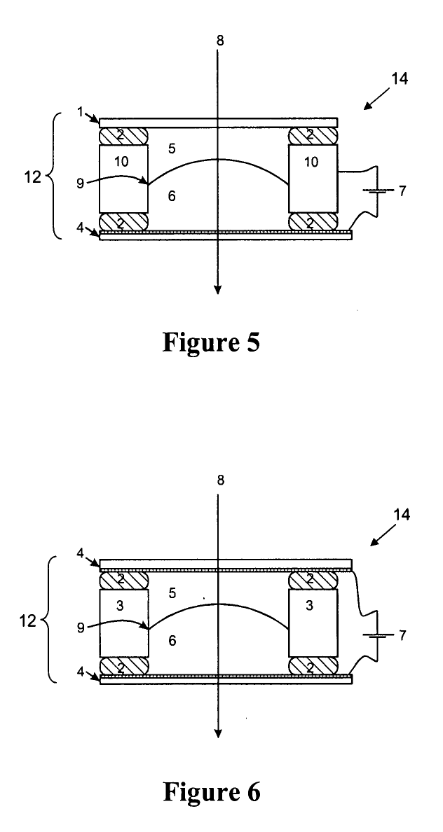

### EXAMPLES 2 to 5 (FIGS. 5 to 8)

FIGS. 5 to 8 are schematic illustrations of electrowetting devices, all of which employ a three-phase boundary between an electrically conductive substrate, usually a metal, and two immiscible electrolytic solutions. A variation of the voltage across the electrodes induces shape change of the interface. This variable-shaped interface may be employed as a variable-focus lens.

### EXAMPLE 2

FIG. 5 illustrates the design of a device which may act as part of some focusing optics. The device has a transparent cover 1, which may be made of glass, and a transparent electrically conductive cover 4. The internal surface of the cover 4 is electrically conductive, thus enabling it to function as an electrode, and may for example be made of indium-doped tin oxide (ITO) covered glass. The side walls 12 of the device comprise an electrode 10, which may be made of nickel metal. The side walls 12 also include electrically-insulating seals 2, which may be made of a silicone elastomer, and by which the electrode 10 is attached to covers 1 and 4. Together, the side walls 12 and covers 1 and 4 form a chamber 14.

Inside the chamber 14 is a first solution 5, composed in this case of 0.5 mol/L lithium chloride, and a second solution 6, composed in this case of 0.01 mol/L TBA-TPB in 1,2-dichloroethane.

The passage of light through the device is indicated by arrow 8.

A power supply 7 is arranged and operable to apply a variable voltage between the wall electrode 10 and the internal (electrode) surface of the cover 4. Within the chamber 14, the three-phase contact line 9 is present on the metal electrode 10. Adjusting the voltage between electrode 10 and the internal electrode surface of cover 4, e.g. approximately over the range −1 V to 1 V, alters the curvature of the interface and changes the focal length of the lens formed by the boundary between the two liquids 5 and 6.

### EXAMPLE 3

FIG. 6 illustrates another example of a device, similar to that of FIG. 5, but in this case employing two transparent electrically conducting covers 4, for example made of ITO glass (as described above), which function as electrodes. The side walls 12 incorporate a wall region 3 made of any suitable material, such as plastic. Electrically-insulating seals 2 are provided for attaching the wall region 3 to the covers 4. Together, the side walls 12 and covers 1 form a chamber 14.

As with Example 2, inside the chamber 14 is a first solution 5 (e.g. 0.5 mol/L lithium chloride) and a second solution 6 (e.g. 0.01 mol/L TBA-TPB in 1,2-dichloroethane). The three-phase contact line 9, between the two liquids 5 and 6, is present on the wall region 3. Thus, in this case, the three-phase contact line 9 is located between the two electrodes (4 and 4), and is not on either.

The passage of light through the device is again indicated by arrow 8.

In this example, the power supply 7 is arranged and operable to apply a variable voltage between the two covers 4 of the device. Adjusting the applied voltage between the two covers 4 alters the curvature of the interface and changes the focal length of the lens formed by the boundary between the two liquids 5 and 6.

### EXAMPLE 4

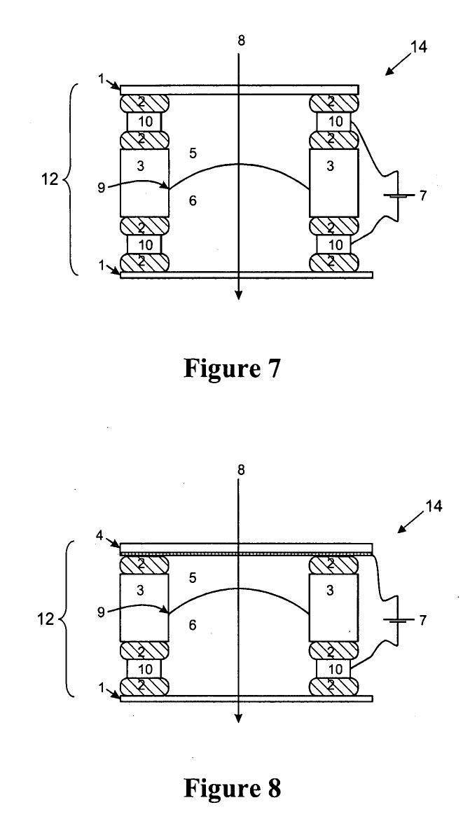

In FIG. 7, the two covers 1 are both transparent (e.g. made of glass). The side walls 12 incorporate a wall region 3 and electrodes 10. The wall region 3 may be made of any suitable material, such as plastic. The electrodes 10 are separated from the wall region 3 and the covers 1 by electrically-insulating seals 2. Together, the side walls 12 and covers 1 form a chamber 14.

As with Examples 2 and 3, inside the chamber 14 is a first solution 5 (e.g. 0.5 mol/L lithium chloride) and a second solution 6 (e.g. 0.01 mol/L TBA-TPB in 1,2-dichloroethane). The three-phase contact line 9, between the two liquids 5 and 6, is present on the wall region 3. Thus, in this case, the three-phase contact line 9 is located between the two electrodes 11, and is not on either.

The passage of light through the device is indicated by arrow 8.

The power supply 7 is arranged and operable to apply a variable voltage between the two electrodes 10. Adjusting the applied voltage between the two electrodes 10 alters the curvature of the interface and changes the focal length of the lens formed by the boundary between the two liquids 5 and 6.

### EXAMPLE 5

The device of FIG. 8 employs one transparent cover 1 (e.g. made of glass) and one transparent electrically conducting cover 4 (e.g. made of ITO glass as described above) which functions as an electrode. The side walls 12 incorporate a wall region 3 made of any suitable material, such as plastic, and an electrode 10. Electrically-insulating seals 2 are provided for attaching the wall region 3 and the electrode 10 to the covers 1, 4. Together, the side walls 12 and covers 1 form a chamber 14.

As with Examples 2, 3 and 4, inside the chamber 14 is a first solution 5 (e.g. 0.5 mol/L lithium chloride) and a second solution 6 (e.g. 0.01 mol/L TBA-TPB in 1,2-dichloroethane). The three-phase contact line 9, between the two liquids 5 and 6, is present on the wall region 3. The three-phase contact line 9 is located between the electrodes (4 and 10), and is not on either.

The passage of light through the device is again indicated by arrow 8.

The power supply 7 is arranged and operable to apply a variable voltage between the electrodes 4 and 10. Adjusting the applied voltage between the two electrodes 10 alters the curvature of the interface and changes the focal length of the lens formed by the boundary between the two liquids 5 and 6.

### 5. Design Parameters for ITICL Electrowetting

The following equations may be useful for the design, optimisation, or modeling of ITICL-based electrowetting devices.

In a particular electrowetting configuration, the entire shape of an ITICL may usually be related by analytical geometry to the contact angle α_{c} between the ITICL and the substrate (e.g., contact angle 112 in FIG. 1). The contact angle α_{c} can be adjusted by a control voltage Φ₀, which a power supply maintains between two electrodes in the device.

The response of an ionic liquid or electrolytic solution to a control voltage is typically gauged by comparing the electrostatic potential (voltage) to the thermal energy. Therefore it may be convenient to rephrase the control voltage as a dimensionless quantity φ₀, defined as

$${φ}_{0} = \frac{Fz {Φ}_{0}}{RT} ,$$

where F is Faraday's constant, R the gas constant, z the equivalent charge of cations in the electrolytes, and T the operating temperature in degrees Kelvin. (At room temperature, φ₀ expresses the voltage in units of ˜25 mV). The electrowetting effect may be characterized for a particular device configuration by measuring α_{c} as a function of φ₀.

Three other dimensionless quantities which characterize the electrowetting of an ITICL are determined by the chemical makeup of the operating liquids and the substrate. These design parameters may not be adjusted during operation of the device. The following discussion applies specifically to electrowetting configurations in which the substrate is an atomically smooth, chemically homogeneous conductor or semiconductor, such that the liquid/substrate interfaces may be treated, to a first approximation, as equipotential surfaces. Also, the discussion applies specifically to systems which are operated at voltages within the ideal polarizability window.

The first, and most basic, design parameter is the contact angle when the control voltage is zero, designated α_{c}⁰. This “zero-voltage contact angle” quantifies the shape of the ITICL when the power supply puts no energy into the system, or, alternatively, when the power supply is disconnected from the electrodes. It may be determined via Young's equation,

$$cos {α}_{c}^{0} = \frac{{γ}_{10} - {γ}_{20}}{{γ}_{12}} ,$$

where γ₁₀ is the interfacial tension between liquid 1 and the substrate, γ₂₀ is the interfacial tension between liquid 2 and the substrate, and γ₁₂ is the interfacial tension between liquid 1 and liquid 2. Interfacial tensions may be lowered by the addition of surfactant additives to the liquids, or may be increased by increasing the electrolyte concentration.

A second design parameter, b, determines the scale of the electrowetting effect at a given control voltage. It may be defined as

$$b = {( \frac{RT}{zF} )}^{2} \frac{\sqrt{{\hat{C}}_{10} {\hat{C}}_{20}}}{{γ}_{12}} ,$$

where Ĉ₁₀ is the specific capacitance (in Farads per unit area) of the liquid 1/substrate interface in the limit of zero control voltage, and Ĉ₂₀ is the specific capacitance of the liquid 2/substrate interface in the limit of zero control voltage. Generally speaking, b is the ratio of the electrostatic energy stored per unit area to the liquid/liquid surface energy.

A third design parameter, C, expresses the ratio of specific capacitances,

$$C = \sqrt{\frac{{\hat{C}}_{10}}{{\hat{C}}_{20}}} .$$

For a given ITICL/substrate configuration, the shape of experimental α_{c}(Δφ) curves tends to be set mainly by C and α_{c}⁰.

In broad terms, the electrowetting response of a given ITICL configuration may be described by a general equation of the form

cos α_{c}−cos α_{c}⁰=bK(φ₀; C,α_{c}⁰),

where the dimensionless function K takes the argument φ₀ as an independent variable, and the arguments C and α_{c}⁰ as parameters. At low potentials, K tends to be proportional to the square of the control voltage, K ∝φ₀². This parabolic dependence has been known for decades, and is exhibited by most electrowetting systems.

However, in electrowetting systems with an ITICL, the parabolic voltage dependence of K (described theoretically in [11]) is observed experimentally only for control voltages at or below Δφ≈1, obviously too low for the accurate simulation of an actual electrowetting device.

The form of the function K at higher voltages can be derived by writing an expression for the system Gibbs free energy, e.g. equation (A.2), which describes dilute electrolytic solutions to a first approximation. The Gibbs energy can then be minimized subject to certain constraints to find the contact angle at the global energy minimum (GEM), which gives a result in the form of the above equation. Generally, K may additionally depend on the type of ITICL contained in the chamber, as well as the chamber geometry.

For instance, in an electrowetting system in the configuration shown in FIG. 1, and containing an ITICL of type 1A, the main physical constraint to be considered is that the droplet 106 and surrounding solution 108 each conserve their volume when a voltage is applied. To a first approximation, the interfacial capacitances in such a system may be written as

$${\hat{C}}_{10} = \frac{{ɛ}_{0} {ɛ}_{1}}{{λ}_{1}} and {\hat{C}}_{20} = \frac{{ɛ}_{0} {ɛ}_{1}}{{λ}_{1}} ,$$

where ε₀ is the permittivity of free space. Here ε₁ is the dielectric constant of the surrounding electrolytic solution 108 (usually taken as the dielectric constant of its solvent) and λ₁ is the Debye length of solution 108, which depends on the molar concentration of electrolyte in liquid 1, c₁ through

$${λ}_{1} = \sqrt{\frac{{ɛ}_{0} {ɛ}_{1} RT}{2 {Fz}^{2} {c}_{1}}} .$$

Similarly, ε₂ is the dielectric constant of the droplet 106, and λ₂ its Debye length, which depends on the molar concentration of electrolyte in the droplet, c₂, through

$${λ}_{2} = \sqrt{\frac{{ɛ}_{0} {ɛ}_{2} RT}{2 {Fz}^{2} {c}_{2}}} .$$

For a type 1A junction, in the configuration depicted in FIG. 1, determination of the GEM with the method described in Appendix A yields

$$cos {α}_{c} - cos {α}_{c}^{0} = 8 b ( \frac{1}{C} - C ) {sinh}^{2} ( \frac{1}{4} Δφ ) .$$

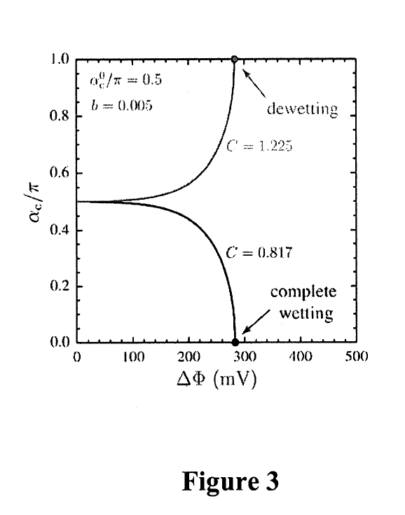

Two theoretical α_{c} (Δφ) curves yielded by this expression are shown in FIG. 3.

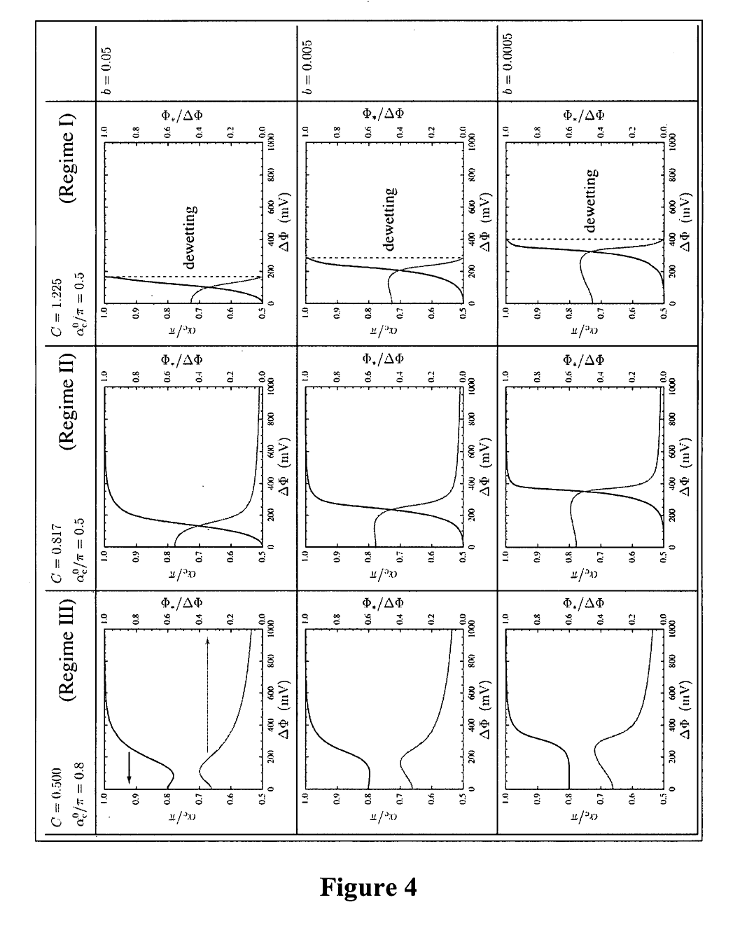

If the configuration shown in FIG. 1 contains an ITICL of type 1B, the specific capacitances are written in the same way as they were for a type 1A junction above (except that in this case, c₁ and c₂ represent the concentrations of two different electrolytes). However, in the ITIES-based configuration, the droplet 106 conserves net charge within its interior, as well as having fixed volume. The method demonstrated in Appendix A shows that the GEM for electrowetting with a type 1B junction is described by equations (A.4) through (A.7), which can also be combined to yield a single relation, in terms of a function K. A number of theoretical α_{c} (Δφ) curves yielded by these equations are plotted in FIG. 4.

The theoretical analysis of type 2 and 3 junctions is more difficult, because at present there is no universally accepted theoretical explanation for the specific capacitance of ionic liquids. However, experiments have shown that in the limit of zero control voltage, specific capacitances at ionic liquid/solid substrate interfaces have similar magnitudes to the specific capacitances typically measured at electrolytic solution/solid substrate interfaces [12]. To deduce the function K for a type 2 or 3 junction, experimental measurements of the specific capacitance may be employed.

### 6. Contact-Angle Hysteresis

During dynamic operation of an electrowetting device, α_{c} may exhibit hysteresis. Hysteresis in this context means a lag in response by α_{c} when the control voltage is changed, or a change in α_{c} which depends on the past history of control voltages. Pinning hysteresis may be attributed to chemical heterogeneity or roughness of the substrate surface [13].

Although the GEM is the most stable state for an electrowetting system, there may be additional local free-energy minima with respect to α_{c}, in which the system may be trapped during dynamic operation. Roughness of the substrate surface, or defects in the substrate's molecular structure, can increase both the number of these minima and their accessibility. Consequently, inhomogeneous substrate surfaces may often exhibit many metastable contact angles.

During a pinning event, the three-phase contact line cannot advance if α_{c} is smaller than a critical advancement angle αₐ, α_{c}<αₐ, and the contact line cannot recede if the contact angle is greater than a critical recession angle αᵣ, α_{c}>αᵣ. The difference between αₐ and αᵣ tends to scale as

$$cos {α}_{r} - cos {α}_{a} \text{:} \frac{Δ E}{{L}^{2} {γ}_{12}} ,$$

where γ₁₂ is the interfacial tension at the interface between liquid 1 and liquid 2, ΔE is the typical energy barrier between two pinned configurations (i.e. the average depth of a local free-energy minimum), and L is a correlation length of the disorder of the surface.

For a given substrate in contact with an ITICL, L can be determined very accurately using in situ scanning-tunnelling microscopy (STM). A typical polished solid surface has roughness with periodicity of order L≈1 μm or less. The value of ΔE can be assessed with the aid of an experimental plot of contact angle vs. control voltage (cf. FIG. 2). In such a plot, the area of the “hysteresis loop” (e.g. the area between the dotted lines 200 in FIG. 2), can be combined with a measure of the charge passed by the power source during traversal of the loop to assess the average magnitude of the local energy barrier which needs to be overcome to reach the GEM.

A transient voltage profile superimposed upon the control voltage may defeat the pinning phenomenon if said voltage profile supplies an additional energy to the system in excess of ΔE. To eliminate or minimize hysteresis this profile may take the form of a small-amplitude oscillating voltage, to be added to the control voltage during the times when the control voltage is being varied.

The oscillation amplitude should not be too large, or it may induce visible fluctuations in the shape of the liquid/liquid interface or in the position of the three-phase contact line. Any amplitude within the ideal polarizability window, e.g. approximately 100 mV, may suffice. The oscillation period, τ, should be greater than the viscous relaxation time of the operating liquids to ensure that they can respond mechanically to the oscillating signal. Thus

τ>L²\sqrt{ρ₁ρ₂}/\sqrt{η₁η₂},

where \sqrt{ρ₁ρ₂} is the geometric mean of the operating-liquid densities and \sqrt{η₁η₂} is the geometric mean of the operating-liquid viscosities. For typical values \sqrt{ρ₁ρ₂}≈10³ kg/m³, \sqrt{η₁η₂}10⁻³ kg/m·s, and L≈1 μm, the oscillation period should be larger than τ≈1 μs (corresponding to oscillation frequencies less than approximately 1 MHz).

The above discussion simply provides order estimates for the characteristics required of an oscillating signal. Both the frequency and the amplitude of a superimposed oscillating voltage may need to be optimized additionally for each geometric configuration of the chamber, each combination of operating liquids, and each substrate material.

Whereas particular embodiments of this invention have been described above for purposes of illustration, it will be evident to those skilled in the art that numerous variations of the details of the present invention may be made without departing from the spirit and scope of the invention.

### REFERENCES

[1] F. Mugele and J-C Baret, J. Phys.: Condens. Matter 17, R705-R774 (2005).
[2] Bruno Berge and Jerome Peseux, inventors. ‘Lens with Variable Focus’, World Intellectual Property Organisation no. 9918456 (France: Univ. Joseph Fourier, 1999);
Bruno Berge, Jerome Peseux, Bertrand Boutaud, and Pierre Craen, inventors. ‘Variable-Focus Lens Assembly’, World Intellectual Property Organisation no. WO 2006/136612 (France: Varioptic, 2006).
[3] Jerome Boutet, inventor. ‘Microfluidic Device for Measuring Fluorescence and Measuring Method Using Same’, World Intellectual Property Organisation no. WO2007/012637 (France: Commissariat Energie Atomique, 2007); Vamsee K. Pamula, Michael G. Pollack, Philip Y. Paik, Hong Ren, and Richard B. Fair, inventors. ‘Methods and Apparatus for Manipulating Droplets by Electrowetting-based Techniques’, U.S. Pat. No. 4,058,450 (United States: Jenkins and Wilson, Pa., 2004).
[4] Andrew Clarke, inventor. ‘Electrowetting Display Element’, World Intellectual Property Organisation no. WO 2005/096066 (United States: Eastman Kodak Company, 2005); Thomas R. Glass, inventor. ‘Electrowetting display’, U.S. Pat. No. 7,167,156 (United States: Micron Technology, Inc., 2007).
[5] T. Chou, Phys. Rev. Lett. 87, 106101 (2001).
[6] H. H. Girault and D. Schiffrin. ‘Electrochemistry of liquid-liquid interfaces’, in Electroanalytical Chemistry, vol. 1, Ed. A. J. Bard (New York: Marcel Dekker, 1985), 1-62.
[8] IUPAC-NIST Solubility Database, http://srdata.nist.gov/solubility
[9] L. Cammarata, S. G. Kazarian, P. A. Salter, and T. Welton, PCCP 3, 5192-5200 (2001).
[10] A. Arce, M. J. Earle, S. P. Katdare, H. Rodríguez, and K. R. Seddon, Chem. Commun., 2548-2550 (2006).
[11] C. W. Monroe, L. I. Daikhin, M. Urbakh, and A. A. Kornyshev, J. Phys.: Condens. Matter 18, 2837-2869 (2006).
[12] C. Nanjundiah, S. F. McDevitt, and V. R. Koch, J. Electrochem. Soc. 144, 3317-3695 (1997).
[13] A. Marmur, Soft Matter 2, 12-17 (2006).
   APPENDIX A: Electrowetting with ITIES

The effect of electric fields on the wetting of solids, called electrowetting, has been studied since the earliest investigations of electrocapillarity [A1]. Today this area has rejuvenated: it pertains to developing technologies such as variable-focus lenses, microfluidic devices, and electronic paper [A2-A4]. Promising applications of electrowetting inspire current experiment and theory [A5-A10].

Typically, the dependence of contact angle on potential is approximated by quadratic laws,

$$cos {α}_{c} = cos {α}_{c}^{0} + \frac{1}{2} B {Φ}_{0}^{2} , \qquad ( A .1 )$$

which follow from the Gibbs adsorption isotherm [A1]. Here α_{c} is the (internal) contact angle of the droplet with the electrode, α_{c}⁰ is the angle at zero voltage, B is an effective specific capacitance per unit surface tension, and Φ₀ is the potential relative to a reference electrode in the medium surrounding the droplet. There are expressions for B when the droplet and surroundings are insulators, when the droplet is perfectly conductive, and in both of these situations with an insulating substrate [A6]. The laws hold at small potential, but do not capture the saturation to a limiting angle observed at large potential [A10-A13].

Recently a new configuration, in which the droplet and its surrounding medium contain mutually immiscible electrolytes, has gathered attention [A14,A15]. Interfaces between two immiscible electrolytic solutions (ITIES) are used for biomimetics, catalysis, surface cleaning, and assembly of nanoparticle arrays [A16,A17]. ITIES are well suited for electrowetting: interfacial capacitances can be tuned independently by adjusting electrolyte concentrations; potentials can be varied widely and electrochemically controlled. This allows detailed characterization of droplet contraction or detachment (dewetting), effects also observed in similar systems [A18,A19].

Electrowetting with ITIES was described at small potentials in Ref. [A20], which gives an expression for B. Here we establish the contact-angle law for a broader potential range. The augmented theory describes contact-angle saturation and dewetting, setting a framework for experimental study of this novel configuration.

Here, a single liquid droplet, 106 (phase d) is considered, which rests on a planar, conductive electrode, 102 (phase e), and is surrounded by an immiscible liquid, 108 (phase s), as shown in FIG. 1. Binary salts are dissolved in each liquid. The salts share no ions and each is immiscible in the adjacent phase, making the boundary between d and s an ITIES. The volume of phase s and the electrode separations are assumed large compared to the droplet; buoyancy is neglected. We seek the dependence of the contact angle, α_{c}, on the potential read by the voltmeter, Φ₀.

### Free-Energy Functional

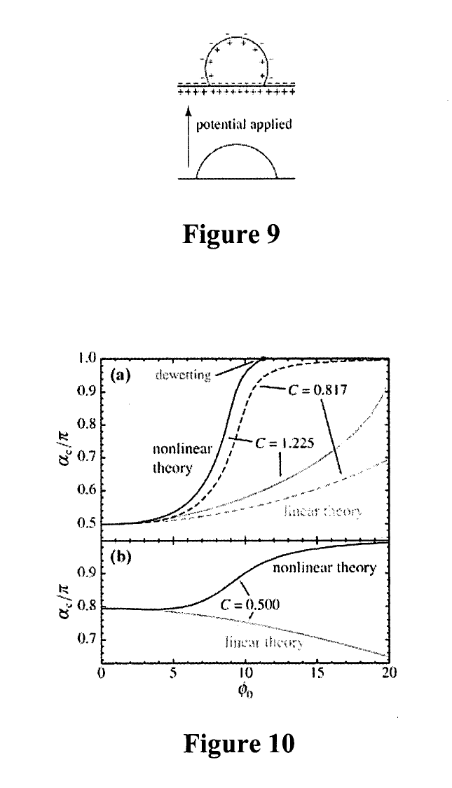

The equilibrium properties of this system can be derived from its Gibbs free energy,

$$G = {\sum }_{j = d , s} {\int }_{{V}_{j}} [ F {\sum }_{i = + , -} {z}_{ji} {c}_{ji} ( Φ - {Φ}_{j}^{ref} ) - \frac{{ɛ}_{0} {ɛ}_{j}}{2} {\vert E \vert}^{2} + RT {\sum }_{i = + , -} ( {c}_{ij} ln \frac{{c}_{ji}}{{c}_{ji}^{ref}} - {c}_{ji} + {c}_{ji}^{ref} ) ] d V + {\sum }_{j = d , s} {p}_{j}^{ref} {V}_{j} + {A}_{de} {γ}_{de} + {A}_{se} {γ}_{se} + {A}_{ds} {γ}_{ds} , \qquad ( A .2 )$$

where F is Faraday's constant, ε₀ the permittivity of free space, R the gas constant, and T the absolute temperature. FIG. 9 shows shape change of the droplet and charge accumulation with potential. + and − denote cations and anions respectively. Integrals over the phase volumes Vⱼ account for electrostatic and mixing free energy. The integrand contains the potential Φ and corresponding electric field magnitude |E|, the dielectric constant of phase j, εⱼ, and the equivalent charge zⱼᵢ and concentration cⱼᵢ of ion i in phase j. Mechanical work, pⱼ^{ref}Vⱼ, is included separately. Remaining terms give the capillary contribution to G, dependent on the areas Aⱼₖ and surface tensions γⱼₖ of the interfaces between phases j and k. Lagrange multipliers constrain G in each phase: Φⱼ^{ref} and cⱼᵢ^{ref}, respectively, determine conservation of charge and ions; pⱼ^{ref} sets the pressure or volume.

Ions cannot cross the droplet boundaries if the liquid/liquid interface is an ITIES. Thus the droplet interior has zero net charge and its net ion contents are fixed. The charge constraint sets Φ_{d}^{ref} and those on ion content determine c_{d+}^{ref} and c_{d-}^{ref}. Electrode separation is large, allowing the surroundings to be considered semi-infinite (Φₛ^{ref}=0). ITIES typically involve symmetric electrolytes with equal cation charge, z≡z_{d+}=−z_{d-}=zₛ₊=−zₛ₋. Then the average ion concentrations cⱼ equate, Cⱼ=cⱼ₊^{ref=c}ⱼ₋^{ref}.

(NOTE: When r_{d} is near λ_{d}, C_{di}^{ref} may depend on r_{d} and Φ₀. But if the surface excess of i is small compared to its average concentration times r_{d}, c_{di}^{ref} equals its average concentration. For large electrode separation distances, c_{di}^{ref} is also equal to its average.)

### Determination of the Global Free-Energy Minimum

Minimization of G with cⱼᵢ at fixed Φ and droplet shape yields Boltzmann distributions in the surroundings and the droplet:

$${c}_{s \pm } = {c}_{s} exp ( m \frac{zF Φ}{RT} ) and {c}_{d \pm } = {c}_{d} exp [ m \frac{zF ( Φ - {Φ}_{*} )}{RT} ] ,$$

where Φ_{*}≡Φ_{d}^{ref} to simplify notation. From minimization of G with respect to Φ at fixed cⱼᵢ and shape, it follows that Φ satisfies Poisson's equation in both liquid phases. Thus each solution obeys a nonlinear Poisson-Boltzmann equation, to be solved such that droplet-electrode interface is at Φ₀ and Φ→0 in the bulk of the surroundings; at the liquid-liquid interface, continuity of potential and electric displacement matches the distributions. Then, setting the net internal droplet charge to zero yields Φ_{*}.

Before the final minimization with respect to shape, it is convenient to eliminate the arbitrary area Aₛₑ, expressing G relative to a system with identical electrode geometry, but with phase s only, at the same Φ₀. Denote the energy of this droplet-free state G⁰ and the relative energy ΔG=G−G⁰. If ΔG>0, the droplet dewets.

### Controlling Parameters

Analysis reveals that four dimensionless parameters determine equilibrium:

$$\begin{matrix}{φ}_{0} = \frac{zF {Φ}_{0}}{RT} , & cos {α}_{c}^{0} = \frac{{γ}_{sc} - {γ}_{dc}}{{γ}_{ds}} , \\ C = \sqrt{\frac{{ɛ}_{s} {λ}_{d}}{{ɛ}_{d} {λ}_{s}}} , & b = {( \frac{RT}{zF} )}^{2} \frac{{ɛ}_{0}}{{γ}_{ds}} \sqrt{\frac{{ɛ}_{d} {ɛ}_{s}}{{λ}_{d} {λ}_{s}}}\end{matrix}$$

Here C is the square root of the ratio of specific capacitances yielded by linear Gouy-Chapman theory [A21,A22] for interfaces between an electrode and solution d or s; Young's equation relates α_{c}⁰ to the surface tensions; the effective specific capacitance per unit surface tension is proportional to b. Both b and C depend on Debye lengths, λⱼ =(ε₀εⱼRT/2F²z²cⱼ)^{1/2}. We also use a second dimensionless potential, φ_{*}=zFΦ_{*}/RT, at which the droplet's local charge density is zero. Thermodynamic stability requires 0≦φ_{*}/φ₀≦1.

In applications the droplet radius is typically larger than a few micrometers. As shown earlier [A20], when the average droplet radius r_{d}>10³λ_{d}, the liquid-liquid interface maintains constant potential, excepting a small region near the three-phase contact line that contributes negligibly to both ΔG and its change with shape. Also, a plateau at φ=φ_{*}, exists over most of the droplet interior. Thus the three-phase region and interfacial curvature may be neglected in the Poisson-Boltzmann equations; geometry enters the potential dependence of ΔG through surface areas A_{de}, and A_{ds} only.

After application of this “large-droplet approximation,” ΔG becomes

$$\frac{Δ G}{{γ}_{ds}} = 8 {bA}_{de} [ C {sinh}^{2} ( \frac{1}{4} {φ}_{0} ) - \frac{1}{C} {sinh}^{2} ( \frac{1}{4} {φ}_{0} - \frac{1}{4} {φ}_{*} ) ] - cos {α}_{c}^{0} {A}_{de} + \frac{{V}_{d}}{{γ}_{ds}} Δ p , \qquad ( A .3 )$$

in which the function ƒ is defined as

$$f ( {φ}_{*} , C ) = {[ {( C + \frac{1}{C} )}^{2} + 4 {sinh}^{2} ( \frac{1}{4} {φ}_{*} ) ]}^{1 / 2} - ( C + \frac{1}{C} ) . \qquad ( A .4 )$$

Here Δp, the external pressure difference between the droplet interior and the droplet-free state, remains to be set by a droplet-volume constraint. The electrostatic contributions to ΔG are scaled by b; the electrostatic-energy contribution by the ITIES is also proportional to f.

To retrieve φ_{*}, one sets the surface charges on the droplet-surroundings and droplet-electrode interfaces to be equal and opposite, yielding

$$A ( {φ}_{*} , {φ}_{0} , C ) = \frac{C sinh ( \frac{1}{2} {φ}_{*} ) / sinh ( \frac{1}{2} {φ}_{0} - \frac{1}{2} {φ}_{*} )}{{[ {( C + \frac{1}{C} )}^{2} + 4 {sinh}^{2} ( \frac{1}{4} {φ}_{*} ) ]}^{1 / 2}} , \qquad ( A .5 )$$

where A=A_{de}/A_{ds} is the ratio of surface areas bounding the droplet. This equation relates the droplet geometry to φ_{*}, making Eq. (A.3) a function of shape parameters only.

### Potential Dependence of Contact Angle

The droplet shape is retrieved by minimization of Eq. (A.3) with V_{d} fixed. This yields an augmented Young-Laplace equation, which shows the droplet to be a truncated sphere and that Δp=−2λγ_{ds}(1−4bƒ)/r_{d}. For a truncated sphere, α_{c} relates to the interfacial areas by

cos α_{c}=2A(φ_{*},φ₀,C)−1. (A.6)

As a result, ΔG in Eq. (3) becomes a simple function of the contact angle. Minimization of ΔG with respect to α_{c} gives

$$8 b [ \frac{1}{C} {sinh}^{2} ( \frac{1}{4} {φ}_{0} - \frac{1}{4} {φ}_{*} ) - C {sinh}^{2} ( \frac{1}{4} {φ}_{0} ) ] + 8 b ( A - \frac{1}{2} ) f + cos {α}_{c}^{0} + 1 - 2 A = 0. \qquad ( A .7 )$$

At fixed applied potential, with ƒ(φ_{*}C) given by Eq. (A.4) and A (φ_{*},φ₀,C) by Eq. (A.5), this is an equation in the single unknown φ_{*}. Once φ_{*} has been found from Eq. (A.7), α_{c} is returned from Eqs. (A.5) and (A.6).

Equations (A.4)-(A.7) constitute the central result of this analysis. These four governing relationships describe how the contact angle between an ITIES and a planar electrode, α_{c}, depends on the applied potential φ₀. Equilibrium is determined by three system characteristics: b, C, and α_{c}⁰.

### Results and Discussion

The present analysis differs from analyses of conventional electrowetting in the assumptions regarding droplet charge. Theories to date have assumed that a net charge accumulates in the droplet with applied potential [A6]. But in electrowetting with an ITIES, ions cannot leave the droplet—it always maintains zero net charge. Potentials therefore cause equal and opposite space charges to accumulate inside the droplet boundaries.

Also, in other analyses the essential potential drop is often taken to occur at the droplet-electrode interface, primarily lowering interfacial energy there. This leads to a prediction of droplet spreading with rising potential. In contrast, with an ITIES, potentials can lower the interfacial energy to a similar extent at every phase boundary: droplets may spread or contract.

Differences in energy lowering at the droplet-electrode and surroundings-electrode interfaces define the direction of contact-angle variation. This is clarified in the limit of dimensionless potentials much less than 1, where Eq. (A.7) reduces to Eq. (A. 1) [A20], with B(b, C, α_{c}⁰) given by

$$B = {bC ( \frac{zF}{RT} )}^{2} [ \frac{{{cos}_{c}^{0} ( 1 + cos {α}_{c}^{0} )}^{2} ( 1 + {C}^{2} ) + 4 {C}^{2}}{{[ {C}^{2} ( 3 + cos {α}_{c}^{0} ) + ( 1 + cos {α}_{c}^{0} ) ]}^{2}} - 1 ] . \qquad ( A .8 )$$

The sign of B is determined by C and α_{c}⁰. Contraction (B<0) occurs whenever the surroundings have a higher Gouy-Chapman capacitance than the droplet (C>1). Spreading (B>0) is only possible when C<1.

(NOTE: Conventional results are not limiting cases of Eq. (A.8); it assumes no net droplet charge. To get a conventional B, set φ_{*}=ƒ=0 in Eq. (A.3), minimize, and take φ_{*}<<1.)

Also, α_{c}⁰ must be obtuse for spreading. To see why, consider separately the capillary and electrostatic contributions to ΔG. Capillary energy is minimal at α_{c}⁰. Electrostatic energy is minimal at the angle which maximizes overall capacitance. Minimal ΔG is realized at an angle between these two minima. If C>1, the electrostatic minimum is at α_{c}=180° (dewetting) because the surroundings have a higher specific capacitance than the droplet interior. Thus, applied potentials always cause contraction. But if C<1, the electrostatic minimum lies at 0<α_{c}<180 (the regime of partial wetting), because net droplet electroneutrality inhibits the space-charge accumulation within it as it spreads. When C<1, the capacitance-maximizing angle is smaller than α_{c}⁰ only if α_{c}⁰>130°.

The theory also rationalizes a more extreme effect—dewetting of droplets at high potential. For C>1 there is a limiting potential above which no physical solution to Eq. (A.7) exists. If the potential exceeds φ₀^{max}(b, C,α_{c}⁰),

$${φ}_{0}^{max} = 2 {cosh}^{- 1} [ 1 + \frac{C ( 1 + cos {α}_{c}^{0} )}{4 b ( {C}^{2} - 1 )} ] ; C > 1 , \qquad ( A .9 )$$

the free-energy minimum lies above the accessible range of contact angles and the droplet dewets. This follows from Eq. (A.7) because φ_{*}→0 as α_{c}→180° (A→0). When C≦1 the droplet remains at the surface, in the regime of partial wetting, at all applied potentials; the contact angle in these cases saturates toward dewetting.

FIG. 10 compares three results yielded by Eqs. (A.4)-(A.7) to the familiar small-potential approximations provided by Eqs. (A. 1) and (A.8). Each curve was calculated with b=0.005, corresponding to a nitrobenzene-water ITIES with 0.01 mol/L concentrations of electrolyte in both liquids. FIG. 10(a) shows two cases with cos α_{c}⁰=0, typical of conductive substrates. Contraction occurs for both C=0.817, representing an aqueous droplet, and C=1.225, an organic droplet. The former approaches dewetting asymptotically and the latter dewets as predicted by Eq. (A.9). Departures from linearity are already clear above φ₀=3 (80 mV at room temperature). FIG. 10(b) presents the surprising results for C=0.5 and cos α_{c}⁰=−0.8. The nonlinear theory predicts spreading, which slows, and then reverses, as φ₀ rises. A striking difference between the nonlinear and linear theories appears at moderate potential. Each nonlinear result in FIG. 10 has an inflection point—the onset of contact-angle saturation—near φ₀=8 (200 mV).

Inflection points arise because the depth of the minimum in electrostatic energy increases exponentially with φ₀. At small φ₀, the electrostatic and capillary contributions to ΔG are of similar magnitude. But above a moderate value of φ₀, determined mainly by b, the electrostatic energy outweighs the capillary energy, and the tendency to maximize capacitance dominates the contact-angle response. The transition manifests as an inflection.

For all combinations of parameters, the contact-angle change with rising φ₀ falls into one of the three categories shown in FIG. 10. Although adjusting b changes the potentials at which dewetting and inflection occur, the shapes of response curves are set primarily by C and α_{c}⁰.

### Concluding Remarks

The presented phase diagram and dependence of inflection-point positions on b both suggest qualitative experimental tests. Given a pair of solvents, one can vary C or b independently by choosing salt concentrations; one can vary α_{c}⁰ either by changing electrode materials or by adding neutral surfactants to the electrolytic solutions.

Several effects of lesser importance were ignored here. Experiments suggest that limited ion penetration can affect the capacitance of ITIES. But if c_{d} and cₛ are ≦0.01 mol/L, the assumption of an impermeable interface applies [A23,A24]. Buoyancy, nonidealities, thin-film forces, and dielectric breakdown were neglected, and the large-droplet approximation is unjustified when the three-phase contact line has radius less than ˜(λ_{d}λₛ)^{1/2}.

For electrowetting with ITIES, nonlinear double-layer charging and ionic impermeability of the liquid-liquid interface control how applied potentials lead to contactangle saturation and droplet dewetting. The analysis presented here provides surprising predictions that can be explored in the laboratory, and, after verification, used to design microfluidic or electro-optical devices.

### REFERENCES FOR APPENDIX A

[A1] V. G. Levich, Physicochemical Hydrodynamics (Prentice-Hall, Englewood Cliffs, N.J., 1962).
[A2] S. Kuiper and B. H. W. Hendriks, Appl. Phys. Lett. 85, 1128 (2004).
[A3] R. A. Hayes and B. J. Feenstra, Nature (London) 425, 383 (2003).
[A4] K. S. Yun, I. J. Cho, J. U. Bu, C. J. Kim, and E. Yoon, J. Microelectromech. Syst. 11, 454 (2002).
[A5] C. Quilliet and B. Berge, Curr. Opin. Colloid Interface Sci. 6, 34 (2001).
[A6] F. Mugele and J.-C. Baret, J. Phys. Condens. Matter 17, R705 (2005).
[A7] K. Kang, I. Kang, and C. Lee, Langmuir 19, 5407 (2003).
[A8] J. Buehrle, S. Herminghaus, and F. Mugele, Phys. Rev. Lett. 91, 086101 (2003).
[A9] J.-C. Baret and M. Brinkmann, Phys. Rev. Lett. 96, 146106 (2006).
[A10] T. Chou, Phys. Rev. Lett. 87, 106101 (2001).
[A11] M. Vallet, M. Vallade, and B. Berge, Eur. Phys. J. B 11, 583 (1999).
[A12] B. Shapiro, H. Moon, R. L. Garrell, and C. J. Kim, J. Appl. Phys. 93, 5794 (2003).
[A13] F. Mugele and S. Herminghaus, Appl. Phys. Lett. 81, 2303 (2002).
[A14] P. Tasakorn, J. Chen, and K. Aoki, J. Electroanal. Chem. 533, 119 (2002).
[A15] T. J. Davies, S. J. Wilkins, and R. G. Compton, J. Electroanal. Chem. 586, 260 (2006).
[A16] H. H. Girault and D. J. Schiffrin, in Electroanalytical Chemistry, edited by A. J. Bard (Marcel Dekker, New York, N.Y., 1985), Vol. 15, p. 1.
[A17] B. Su, J. P. Abid, D. J. Fermin, H. H. Girault, H. Homannova, P. Krtil, and Z. Samec, J. Am. Chem. Soc. 126, 915 (2004).
[A18] J. Yoshida, J. Chen, and K. Aoki, J. Electroanal. Chem. 553, 117 (2003).
[A19] A. Rowe, R. Counce, S. Morton, M. Hu, and D. DePaoli, Ind. Eng. Chem. Res. 41, 1787 (2002).
[A20] C. W. Monroe, M. Urbakh, L. I. Daikhin, and A. A. Kornyshev, J. Phys. Condens. Matter 18, 2837 (2006).
[A21] G. L. Gouy, J. Phys. Theor. Appl. 9, 457 (1910).
[A22] D. L. Chapman, Philos. Mag. 25, 475 (1913).
[A23] Z. Samec, V. Marecek, and D. Homolka, Faraday Discuss. Chem. Soc. 77, 197 (1984).
[A24] C. W. Monroe, M. Urbakh, and A. A. Kornyshev, J. Electroanal. Chem. 582, 28 (2005).

1. A device comprising:
a chamber containing two immiscible conductive liquids, the liquids having an interface therebetween; and
electrodes arranged to apply a voltage across the interface between the said liquids such as to control the shape of the interface.

2. A device as claimed in claim 1, wherein the two immiscible conductive liquids are both electrolytic solutions.

3. A device as claimed in claim 2, wherein the electrolytic solutions are immiscible solvents containing a mutually miscible electrolyte.

4. A device as claimed in claim 2, wherein the electrolytic solutions are immiscible solvents, and wherein each solvent contains a dissolved electrolyte which is immiscible in the other solvent.

5. A device as claimed in claim 1, wherein one immiscible conductive liquid comprises an electrolytic solution and another immiscible conductive liquid comprises an ionic liquid.

6. A device as claimed in claim 1, wherein the two immiscible conductive liquids are both ionic liquids.

7. A device as claimed in claim 1, wherein at least one electrode is a metal electrode.

8. A device as claimed in claim 1, wherein at least one electrode is a semiconductor electrode.

9. A device as claimed in claim 1, wherein the chamber comprises one or more sidewalls and a bottom and/or top cover.

10. A device as claimed in claim 9, wherein one or both of the said cover(s) are optically transparent.

11. A device as claimed in claim 10, wherein one or both of the said cover(s) are electrically conductive such that they can function as electrodes.

12. A device as claimed in claim 9, wherein the sidewall(s) comprise an electrode.

13. A device as claimed in claim 12, wherein the interface between the two immiscible conductive liquids is in contact with the said electrode.

14. A device as claimed in claim 12, wherein the sidewall(s) further comprise a second electrode.

15. A device as claimed in claim 14, wherein the interface between the two immiscible conductive liquids is located between the first and second electrodes.

16. A device as claimed in claim 9, wherein the sidewalls comprise one or more seals.

17. A device as claimed in claim 1, further comprising a power supply arranged to apply a control voltage across the interface.

18. A device as claimed in claim 17, wherein the magnitude of the control voltage is of the order of 1 V or less.

19. A device as claimed in claim 17, wherein the power supply is operable to vary the control voltage.

20. A device as claimed in claim 19, wherein the power supply is arranged to superimpose an oscillating voltage onto the control voltage whilst varying the control voltage.

21. A device as claimed in claim 20, wherein the oscillating voltage has an amplitude of the order of 100 mV or less.

22. A device as claimed in claim 20, wherein the oscillating voltage has a frequency of the order of 1 MHz or less.

23. A method for controlling the shape of an interface between two liquids, the method comprising:
providing two immiscible conductive liquids in a chamber, the said liquids having an interface therebetween; and
applying a voltage across the interface between the said liquids.

24. A method as claimed in claim 23, wherein the two immiscible conductive liquids are both electrolytic solutions.

25. A method as claimed in claim 24, wherein the electrolytic solutions are immiscible solvents containing a mutually miscible electrolyte.

26. A method as claimed in claim 24, wherein the electrolytic solutions are immiscible solvents, and wherein each solvent contains a dissolved electrolyte which is immiscible in the other solvent.

27. A method as claimed in claim 23, wherein one immiscible conductive liquid comprises an electrolytic solution and another immiscible conductive liquid comprises an ionic liquid.

28. A method as claimed in claim 23, wherein the two immiscible conductive liquids are both ionic liquids

29. A method as claimed in claim 23, wherein the step of applying the voltage comprises applying a control voltage.

30. A method as claimed in claim 29, wherein the magnitude of the control voltage is of the order of 1 V or less.

31. A method as claimed in claim 29, further comprising the step of varying the control voltage to control the shape of the interface between the said liquids.

32. A method as claimed in claim 31, further comprising the step of applying a superimposed oscillating voltage onto the control voltage whilst varying the control voltage.

33. A method as claimed in claim 32, wherein the oscillating voltage has an amplitude of the order of 100 mV or less.

34. A method as claimed in claim 32, wherein the oscillating voltage has a frequency of the order of 1 MHz or less.

35. A device comprising:
a chamber containing two immiscible conductive liquids, the liquids having an interface therebetween;
electrodes arranged to apply a control voltage across the interface between the said liquids such as to control the shape of the interface; and
a power supply arranged to apply the control voltage to the said electrodes;
wherein the power supply is operable to vary the control voltage, and is arranged to apply a further superimposed oscillating voltage signal whilst varying the control voltage.

36. A method for controlling the shape of an interface between two liquids, the method comprising:
providing two immiscible conductive liquids in a chamber, the said liquids having an interface therebetween;
applying a control voltage across the interface between the said liquids;
varying the control voltage to control the shape of the interface between the said liquids; and
applying a further superimposed oscillating voltage signal whilst varying the control voltage.

37. A lens comprising a device as claimed in claim 1.

38. A micro-fluidic device comprising a device as claimed in claim 1.

39. An electronic display comprising a device as claimed in claim 1.

40. A device substantially as herein described with reference to and as illustrated in any combination of the accompanying drawings.

41. A method for controlling the shape of an interface between two liquids substantially as herein described with reference to and as illustrated in any combination of the accompanying drawings.
